(19) United States
(12) Patent Application Publication
(10) Pub. No.: US 2025/0181689 A1
(43) Pub. Date: Jun. 5, 2025

(54) SYSTEM AND METHOD FOR BIOMETRIC-BASED IDENTITY VERIFICATION VIA AN OPTICAL SIGNAL

(71) Applicant: Armatura LLC, Alpharetta, GA (US)

(72) Inventors: Zhinong Li, Alpharetta, GA (US); Xiaowu Zhang, Alpharetta, GA (US)

(21) Appl. No.: 18/529,816

(22) Filed: Dec. 5, 2023

(51) Int. Cl. G06F 21/32

(52) U.S. Cl. CPC G06F 21/32

(57) ABSTRACT

The present teaching relates to biometric-based verification via an optical signal. An electronic pass to attend a future event is obtained by a user via a handheld device with parameters associated therewith. Biometric information of the user is acquired via a sensor embedded in the handheld device. Biometric features, the electronic pass, and a time stamp are encrypted to create an optical signal on the hand held device. At the site of the future event, the user presents, using the handheld device, the optical signal for verifying the valid entrance to the future event.

### BACKGROUND

### 1. Technical Field

The present teaching generally relates to computers. More specifically, the present teaching relates to biometric-based verification for access control.

### 2. Technical Background

With the development of the Internet and the ubiquitous network connections, more and more secure access controls are done by authenticating a person via his/her biometrics. For example, most smart phones nowadays are capable of secure access via either fingerprint or face based biometric-based authentication. FIGS. 1A-1B illustrate some examples. FIG. 1A shows that a user may set up on a phone to acquire the user's fingerprint 100 for authentication in future secure access and later the user may submit the fingerprint 110 whenever accessing the phone or other applications residing on the phone. FIG. 1B shows to use alternatively a user's face as biometric information for access control on a phone. The face of a user 120 may be acquired by the camera on a phone and the acquired face information may be processed and stored on the phone for authentication. In accessing the phone or applications resided thereon in the future, the user's face 130 may be acquired again and compared with the stored face information for authentication.

Smart phones today may also be used for secure access control at public places as well such as airports, government buildings, or movie theaters, as illustrated in FIGS. 1C-1D. To convenience travelers, airlines often provide applications that may be downloaded on phones for, e.g., online check-in, baggage check, and obtaining boarding passes. Frequently, a boarding pass may be delivered to a phone in the form of, e.g., a bar code 140, together with other information such as the identity of the traveler and the flight/gate/seat numbers. The traveler may present the barcode at the secure check point 150 at the airport and be allowed to enter the boarding area 160 if the traveler's identity is verified by the airport security personnel. In some embodiments, the verification is performed manually and in other embodiments, the verification is performed by acquiring the biometric information of the traveler and compared with the biometric information of the traveler previously acquired and stored by the airport authority.

In another example illustrated in FIG. 1D, a handheld device such as a phone may also be used to achieve access control to a social event. A user may purchase a ticket/pass to an event such as a movie or a play at a theater with a selected date, time, and seat and obtain an electronic pass with the selected date, time, and seat displayable on the phone. At the event, the user may present the pass information 170 on the phone to an usher 180 standing at the entrance for admission. In some events, identity verification in addition to the electronic pass may also be needed in order to gain entrance or access to the locale (e.g., theater 190) of the event. This may also involve manual checking of the information on the pass with the information related to the event to ensure that the user did come to the correct event with the correct pass and possibly the correct identity.

The current authentication/verification processes performed in connection with information stored in a phone are not efficient, inflexible, and often labor intensive and hence, time consuming. Thus, there is a need for a solution that addresses the issues identified herein.

### SUMMARY

The teachings disclosed herein relate to methods, systems, and programming for information management. More particularly, the present teaching relates to methods, systems, and programming related to hash table and storage management using the same.

In one example, a method, implemented on a machine having at least one processor, storage, and a communication platform capable of connecting to a network for biometric-based verification via an optical signal. An electronic pass to attend a future event is obtained by a user via a handheld device with parameters associated therewith. Biometric information of the user is acquired via a sensor embedded in the handheld device. Biometric features, the electronic pass, and a time stamp are encrypted to create an optical signal on the hand held device. At the site of the future event, the user presents, using the handheld device, the optical signal for verifying the valid entrance to the future event.

In a different example, a system is disclosed for biometric-based verification via an optical signal. The system includes a pass authorization application and an entrance admission unit. The pass authorization application is operating on a handheld device and is provided for a user to obtain remotely an electronic pass to attend an event at a future time with certain parameters in connection with the event, acquire biometric information of the user using a sensor in the handheld device, generate a time stamp of current date/time of the electronic pass, and create an optical signal on the handheld device that encrypts information needed for verifying the entrance to the event. The entrance admission unit is provided for receiving the optical signal, presented subsequently by the user at the event via the handheld device, for verification prior to entering the event.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for biometric-based verification via an optical signal. The information, when read by the machine, causes the machine to perform the following steps. An electronic pass to attend a future event is obtained by a user via a handheld device with parameters associated therewith. Biometric information of the user is acquired via a sensor embedded in the handheld device. Biometric features, the electronic pass, and a time stamp are encrypted to create an optical signal on the hand held device. At the site of the future event, the user presents, using the handheld device, the optical signal for verifying the valid entrance to the future event.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1A-1D illustrates examples of secure access using handheld devices;

FIG. 2A depicts an exemplary high level system diagram of an identity authentication/verification framework for controlled access via biometrics in connection with an optical signal with encoded verification information, in accordance with an embodiment of the present teaching;

FIGS. 2B-2D illustrates exemplary types of information that may be encoded in an optical signal for controlled access, in accordance with an embodiment of the present teaching;

FIG. 3A is a flowchart of an exemplary process of creating an optical signal encoding biometrics and event information for identity authentication/verification in connection with controlled access of an event, in accordance with an embodiment of the present teaching;

FIG. 3B is a flowchart of an exemplary process of identity authenticating/verifying for controlled access based on an encoded optical signal and real-time biometrics acquisition, in accordance with an embodiment of the present teaching;

FIG. 4A depict an exemplary high level system diagram of a pass authorization module, in accordance with an embodiment of the present teaching;

FIG. 4B is a flowchart of an exemplary process of a pass authorization module, in accordance with an embodiment of the present teaching;

FIG. 5A depicts an exemplary high level system diagram of an entrance admission unit, in accordance with an embodiment of the present teaching;

FIG. 5B is a flowchart of an exemplary process of an entrance admission unit, in accordance with an embodiment of the present teaching;

FIG. 6 is an illustrative diagram of an exemplary mobile device architecture that may be used to realize a specialized system implementing the present teaching in accordance with various embodiments; and

FIG. 7 is an illustrative diagram of an exemplary computing device architecture that may be used to realize a specialized system implementing the present teaching in accordance with various embodiments.

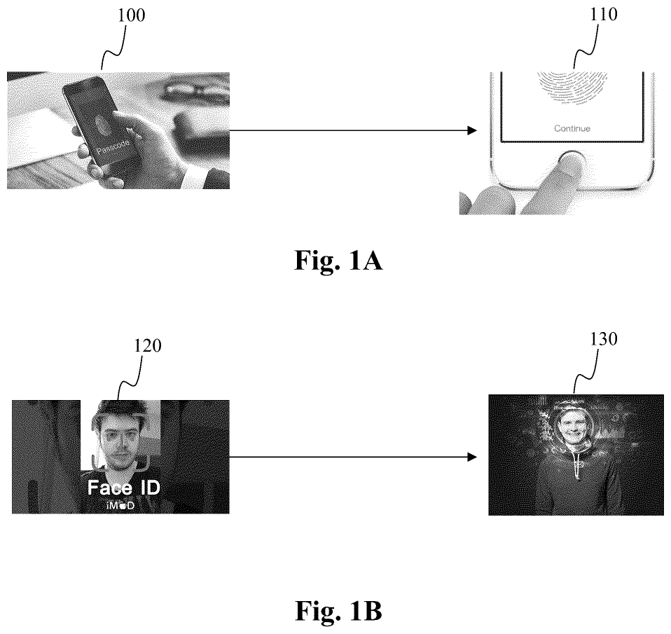

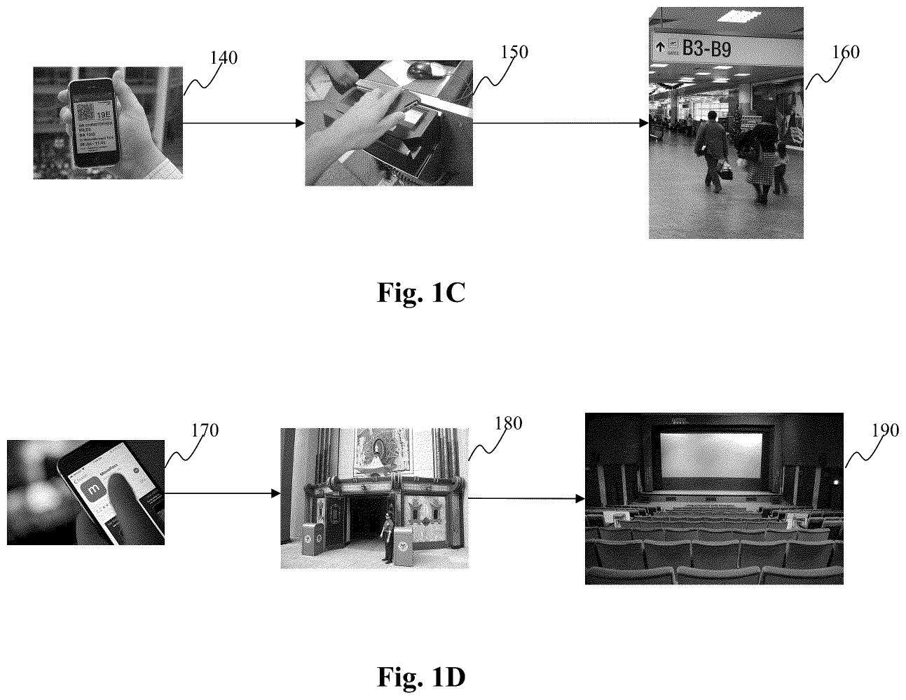

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching discloses framework, system, and method for accessing controlled location by verifying previously authorized personnel via biometric information from an encoded optical signal generated on a handheld device based on the previously granted authorization. For example, an authorized pass for a person to attend an event may be obtained via Internet prior to the event using a handheld device. The authorized pass may include information related to the event such as an identifier of the event, a date, a time, and optionally some seating information if applicable such as seating information. To facilitate the authorized entrance to the event at a future time, the handheld device of the person may acquire, using the sensors available on the device, biometric information of the authorized person and encode information needed for the person to be verified at the time of the entrance. The information to be encoded may include the authorized pass, the biometric information of the person, a time stamp, etc. and is used by the handheld device to generate accordingly an optical signal such as a barcode.

The optical signal may be used for verifying the authorized pass and the identity of the person who has granted the authorization. When the optical signal is presented at the event, it may be decoded, and on-site biometric information of the person may be acquired and used to compare with the previously acquired biometric information to ascertain that the person who appears at the event corresponds to the person who was previously authorized. In addition, other information may be decoded from the optical signal, including but is not limited to, an identifier of the event, a date/time of the event, and a time stamp representing a date/time that the pass was created. Such additional decoded information may also be used to ensure that the access is permitted. For instance, the time stamp may be used to check whether the pass has been expired. The identifier of the event may be used to see whether it is the correct event, etc. The decoded information may also be used to, e.g., marking the entrance of the person as completed so that no additional entrance will be permitted. The verification framework as disclosed herein according to the present teaching addresses the issues associated with the current approaches. It verifies the valid access not only in terms of space but also in terms of time due to the time stamp encoded in the optical signal at the time of creation.

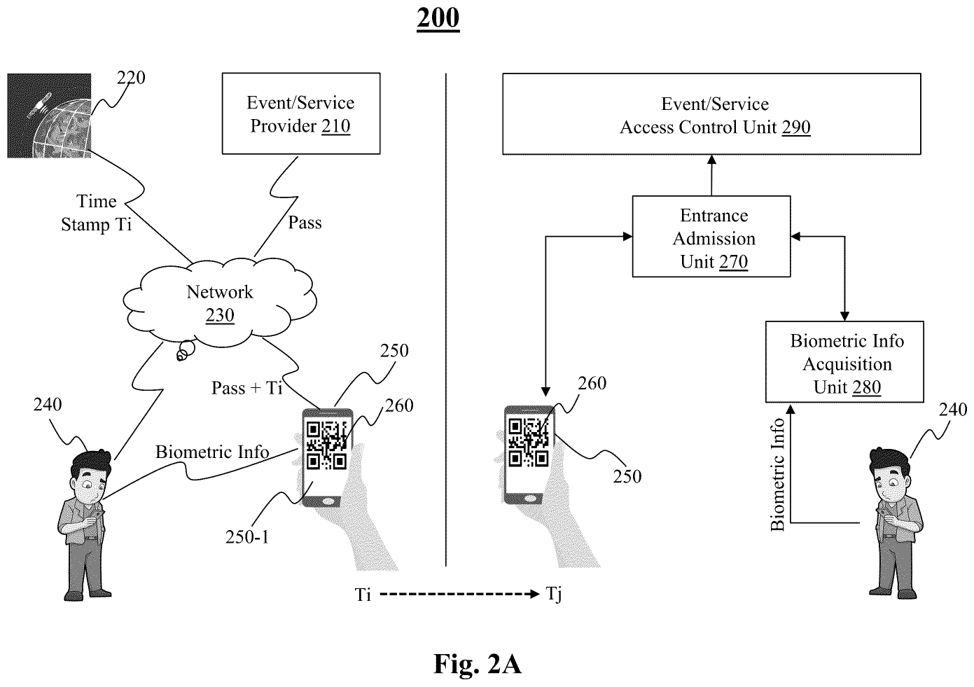

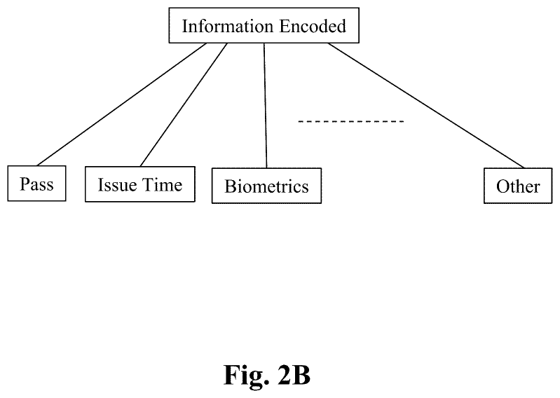

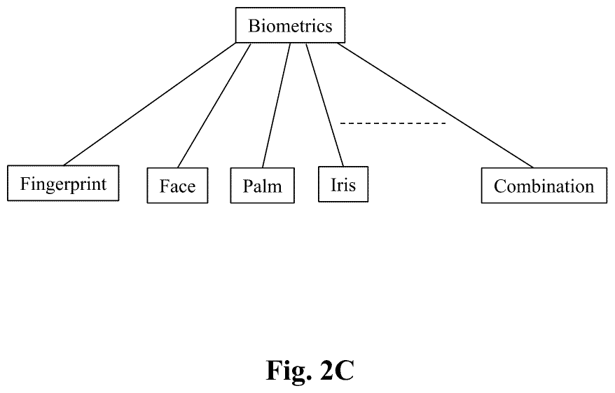

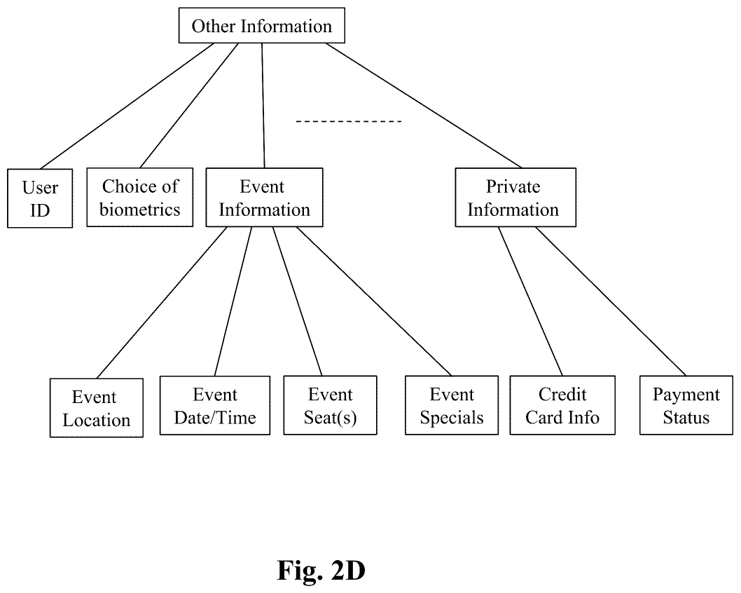

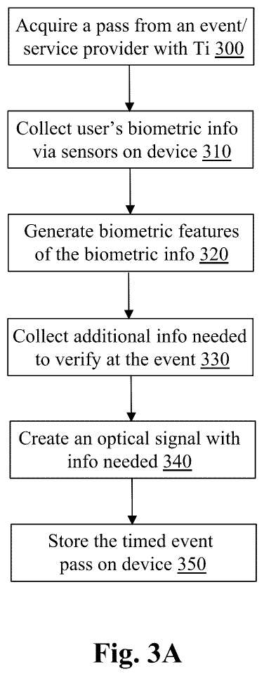

FIG. 2A depicts an exemplary high level system diagram of an identity authentication/verification framework 200 for controlled access by verifying a previously authorized person via biometric information encoded in an optical signal on a handheld device, in accordance with an embodiment of the present teaching. The framework 200 comprises two parts, which operates at different times. The first part is for creating, at time Ti, an optical signal encoding a timed pass to an event authorized to a person verifiable via biometric information acquired from the person at time Ti via a handheld device. The second part operates at a different time, say Tj, which is later in time as compared with Ti, for controlled access of the person to the event by verifying the identity of the person as the one previously authorized as well as the validity of the pass as to time, location, etc.

The first part includes a network 230 connecting to different parties, including an event/service provider 210, a networked source 220 for obtaining standard date/time, a handheld device 250 of a user 240. In some embodiments, the handheld device 250 may have a pass authorization application 250-1 operating thereon for assist the user to communicate with the event/service provider 210 to obtain remotely a pass for an event. The event/service provider 210 may be a party that is responsible for an event and/or operations thereof. For instance, the event/service provider 210 may correspond to an organizer of the event, a host of the event, an event operator that may be responsible for managing the event. The networked source 220 may be of any party that operates an accessible means from where a standard time (date/time) associated with a particular time zone may be obtained. For instance, the networked source 220 may be any of the Time Zone location web services, accessible via, e.g., Google Maps time zone application programming interface (API), Bing Maps time zone API, Azure Maps time zone API, GeoNames time zone API, etc.

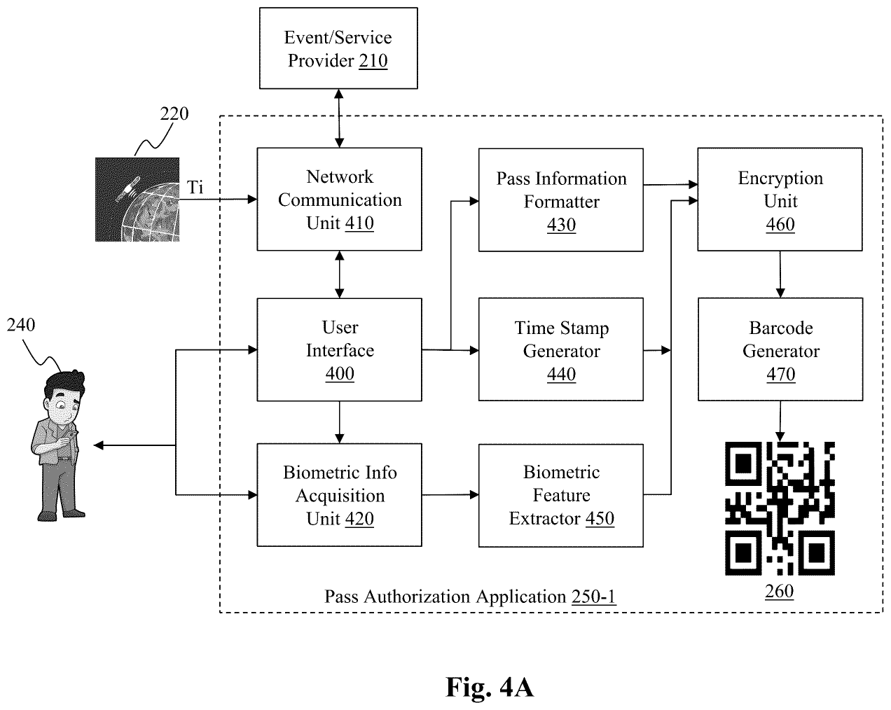

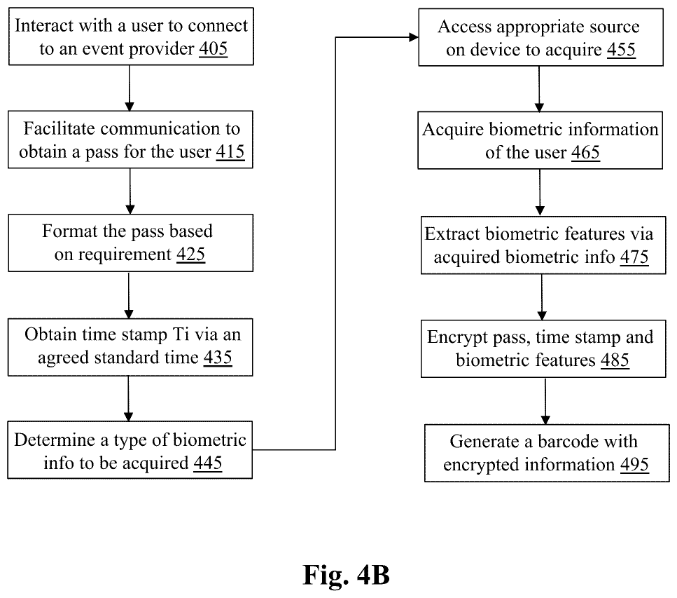

The handheld device 250 may be of any device that can be operated by the user 240 to connect to the network 230, e.g., via the pass authorization application 250-1, to communicate with the event/service provider 210 via an application interface, to use appropriate sensor(s) on the device to acquire the user's biometric information, to process various relevant information such as the biometric information, and to encode such information to create an optical signal such as a barcode. The handheld device 250 may be used to display the optical signal (260) when needed, and to be carried by the user (mobile) to the site of an event. In some embodiments, the optical signal may also be generated as a bitstream which may be transmitted, either via wireless connection or a wired connection, from the handheld device 250 to, e.g., the event/service provider 210 or any other party. In this case, the pass authorization application 250-1 residing on the handheld device 250 may be provided with an interface capable of communicating with the event/service provider 210 to, e.g., transmitting the optical signal to the event/service provider 210 in order to gain access to an event. Such a handheld device may include, but is not limited to, a smart phone, a tablet, a wristwatch, a personal data assistant, or any other devices that allow the tasks as discussed herein. The pass authorization application 250-1 may reside on the handheld device as a downloaded and operable application. Details about the pass authorization application 250-1 are provided with reference to FIGS. 4A-4B.

When the user desires to participate an event provided by the event/service provider 210, the user may contact, e.g., via an application operating on the handheld device 250 or via a website, the event/service provider 210 to sign up for the event and to obtain information therefrom associated with getting a pass to the event. The sign up may include selecting a particular event such as specifying a particular movie at a movie theater on a certain date and time and making a payment for the cost of the event. Upon receiving the sign up and payment information from the user, the event/service provider 210 may generate a timed pass which includes information associated with the event and a time of issuing the pass Ti, obtained, e.g., from the networked source 220. The pass and the time stamp Ti may then be sent to the user's handheld device 250 for encoding to generate an optical signal. This is shown in FIG. 2B, where the information to be encoded into the optical signal may include the pass itself with event information, the time of issuing the pass Ti, and the biometric information of the user, etc.

In some implementations, when the timed pass is sent to the user, the event/service provider 210 may instruct, e.g., via an application through which the user signs up for the event, the user to acquire his/her own biometric information to generate the base biometric information for on-site identity verification for controlled access to the event. In some embodiments, the application associated with the event/service provider 250 may be configured for working in collaboration with appropriate sensors on the device to acquire such biometric information. Depending on the sensors available on the handheld device 250, different types of biometric information may be acquired and used for verification. FIG. 2C illustrates different types of biometric information that may be acquired and used for on-site identity verification, in accordance with an embodiment of the present teaching. It may include fingerprint, face, palm, iris, etc. For example, a camera on the device may be controlled to acquire the face of the user. As another example, a sensor on the device may be controlled to acquire a fingerprint. In some embodiments, a single type of biometric information may be used. In some embodiments, a combination of different types of biometric information may be used for verification.

To carry out the on-site verification at the event, additional information may also be encoded. FIG. 2D illustrates different types of information, in accordance with an embodiment of the present teaching. For instance, an identification of the pass may be collected and encoded. Information about the type(s) of biometric information (choice of biometrics) acquired by the handheld device 250 may also be encoded so that when decoded at the event site, it may be used to control the verification process. Specific information about the event such as location, date, time, seating, or any specials (such as VIP status of the user) may also be included. In addition, certain private information may also be encoded such as the payment status or credit card information provided for, e.g., future charges at the event. Such information, when decoded at the event, may assist the event/service provider 210 to facilitate appropriate services to users according to the level of services signed up by different users. Upon different information associated with the registered event is collected, the application (associated with the event/service provider 210) running on the handheld device 250 may then generate an optical signal 260 that encodes the collected information in a encrypted form which may be read by the event/service provider 210 when the user attends the event at time Tj.

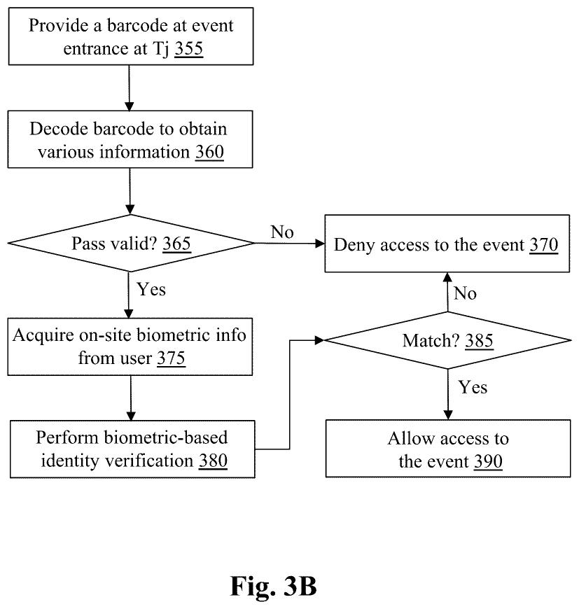

FIG. 3A is a flowchart of the exemplary process of the first part of the framework 200 for creating an optical signal on a handheld device which encodes information needed for verifying a person in connection with controlled access to an event, in accordance with an embodiment of the present teaching. A user (240) may use a handheld device (250) to acquire, at 300 via, e.g., a network connection (230), a pass from the event/service provider 210 at time Ti. Upon receiving the timed electronic pass from the event/service provider 210, the handheld device 250 may collect, at 310, the user's biometric information via sensors on the device in accordance with, e.g., either an instruction received together with the electronic pass, or the program built in an application running on the handheld device. The acquired biometric information may be processed to generate, at 320, corresponding biometric features which may correspond to a condensed representation of the biometric information and may be used for identity verification.

As discussed herein, to generate an optical signal encoded with information needed for on-site verification, different types of information as exemplified in FIG. 2D may be collected, at 330, that is needed (e.g., required by the event/service provider 210) for on-site verification. Based on the collected information, the handheld device (or an application operating thereon) may create, at 340, an optical signal such as a barcode that encodes all the information collected for the on-site verification. The created optical signal is then stored on the handheld device 250 for future verification of the authorized access to the event.

As discussed herein, the framework 200 also includes the second part for access control to an event via verification of both the validity of a pass and the identity of a user presenting the pass. The second part operates at a different time, say time Tj, which is later in time as compared with time Ti when the optical signal or a timed pass is created. In the illustrated embodiment as shown in FIG. 2A, the second part of framework 200 comprises an entrance admission unit 270, a biometric information acquisition unit 280, and an event/service access control unit 290. When a user 240 arrives at the site of an event, the user may present an optical signal such as a barcode 260 on a handheld device 250 to the entrance admission unit 270 to gain access to the event. For instance, the entrance admission unit 270 may provide a barcode reader so that the user may display the barcode on the handheld device and then present the barcode to the reader. There may be other communication means to deliver the optical signal to the entrance admission unit 270.

Upon obtaining the optical signal, the entrance admission unit 270 may decode the optical signal 260 to derive various information needed to verify the validity of the pass as well as the identity of the user. In some embodiments, the validity of the pass may be determined based on, e.g., a duration of time that has passed since the creation of the pass at Ti. That is, the duration between Ti and Tj may be required to be smaller than a certain threshold, e.g., 30 days. A pass that is created before a certain length of time may be deemed as invalid so that the entrance to the event may be denied. For instance, if the event at issue is a concert to be held regularly, e.g., every Sunday. A user may purchase a ticket to the concert, but the ticket may be limited to any Sunday within the next 30 days. In this case, the user may attend the concert held on any Sunday before 30 days from Ti. Once the user arrives at the site at Tj which is past 30 days from Ti, the access will not be permitted.

Upon the validity of the pass is verified, the entrance admission unit 270 may proceed to verify the identity of the user presenting the pass. To do so, the entrance admission unit 270 may determine, based on the decoded information, the type of biometric information to be used for the identity verification and invoke the biometric information acquisition unit 280 to obtain on-site biometric information of the user. To facilitate verification using different types of biometric information, the biometric information acquisition unit 280 may be provided to acquire needed types of biometric information and equipped with different sensing means to obtain appropriate types of biometric information. Depending on the instruction from the entrance admission unit 270 on specific type(s) of biometric information to be acquired, the biometric information acquisition unit 280 requests the user to present certain part of their body (e.g., finger, face, palm, or eye) for the acquisition. The acquired on-site biometric information may then be provided to the entrance admission unit 270 for verifying the identity of the user by comparing the previously acquired biometric information at the time of creating the pass with the on-site biometric information.

If the identity of the user is not verified, the access to the event may be denied. If the user at the site matches with the user who requested the pass, the access is permitted. In this case, the event/service access control unit 290 may be provided as a controllable physical security gate which operates according to a decision (e.g., open the gate or close the gate) from the entrance admission unit 270. In some embodiments, in addition to pass validity and identity verification, there may be other steps to be completed before access is permitted. For instance, the payment status may also be verified. The optical signal may include such information to indicate, e.g., the payment has been made. However, the event/service provider 210 may not receive the payment due to, e.g., the payment was later denied by the bank. The entrance admission unit 270 may also be provided to verify that the payment status is acceptable at the time of the event. As another example, the transaction between a user and the event/service provider 210 at the time of requesting a pass may be to charge the user for the cost of the event at a time when the user shows up at the event. In this case, the credit card information may be encoded in the optical signal and decoded automatically so that the entrance admission unit 270 may initiate an online transaction by charging the cost to the credit card and the user is provided with access only when the payment goes through.

FIG. 3B is a flowchart of an exemplary process of the second part of framework 200 for verifying authorized access based on an encoded optical signal and on-site biometric information, in accordance with an embodiment of the present teaching. A user who desires to attend an event previously obtained an electronic timed pass according to the present teaching. When the user arrives at the site of the event, the user may provide, at 355, the optical signal or a barcode encoded with information associated with the pass to the entrance admission unit 270, which decodes or decrypt the barcode at 360 to obtain various types of information encoded therein, including content of the pass (identifier, location, date/time, seating, etc.), time of the ticket issuance Ti, biometric information of the holder of the pass, type of biometric information, etc. Based on the pass issuance time T1, the entrance admission unit 270 check the validity of the pass. If the pass is invalid, determined at 365, the entrance admission unit 270 instructs the event/service access control unit 290 to deny the access at 370.

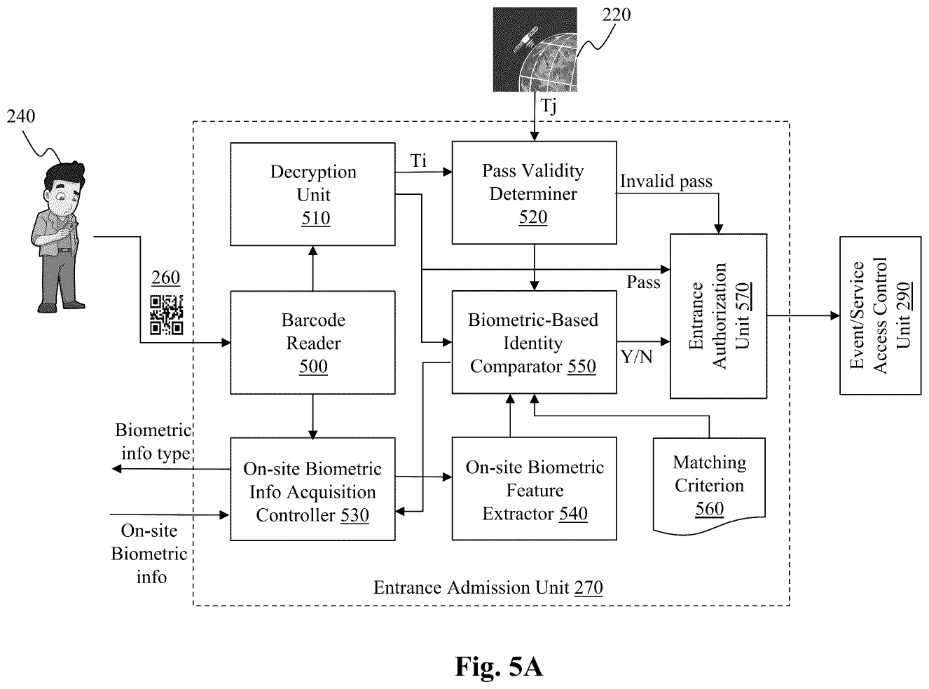

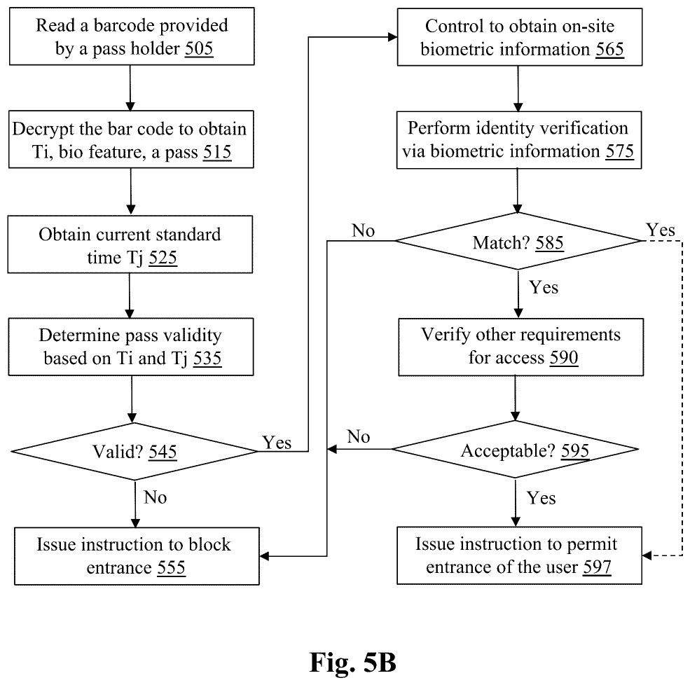

If the pass is valid, the entrance admission unit 270 determines the type of on-site biometric information to be acquired for identity verification and invokes the biometric information acquisition unit 280 to acquire, at 375, on-site biometric information from the user. Such acquired on-site biometric information is then used by the entrance admission unit 270 to perform, at 380, the biometrics-based identity verification. If the on-site biometric information matches with the previously acquired biometric information (from the optical signal), determined at 385, the entrance admission unit 270 controls the event/service access control unit 290 to allow, at 390, the user's access to the event. Otherwise, the event/service access control unit 290 denies, at 370, the user's access to the event. There may be other conditions to be checked and verified in different implementations. Details about the entrance admission unit 270 are provided with reference to FIGS. 5A-5B.

FIG. 4A depict an exemplary high level system diagram of the pass authorization application 250-1, in accordance with an embodiment of the present teaching. In this illustrated embodiment, the pass authorization application 250-1 may be constructed to create an optical code in the form of a barcode to encrypt the information needed for the on-site verification. Other forms of an optical signal may also be created for access control. In this exemplary implementation, the pass authorization application 250-1 comprise a user interface 400, a network communication unit 410, a biometric information acquisition unit 420, a pass information formatter 430, a time stamp generator 440, a biometric feature extractor 450 an encryption unit 460 and a barcode generator 470. FIG. 4B is a flowchart of an exemplary process of the pass authorization application 250-1, in accordance with an embodiment of the present teaching.

The user interface 400 is provided to interface, at 405, with user 240 and the network communication unit 410 to facilitate, at 415, needed communication to collect information to be encoded in an optical signal for verification. The user may search for different events/services available and communicate, via the user interface 400, with an event/service provider 210 to provide information needed or make payment to obtain a pass for a selected event. Information related to the pass on the selected event (e.g., date, time, seat, payment method, etc.) may be gathered via the user interface 400 and provided to the event/service provider 210 through the network communication unit 410. With the information provided, the event/service provider 210 may issue a pass for the selected event and send a pass to the pass authorization application 250-1. In some embodiments, the pass from the event/service provider 210 may be already time stamped with Ti. In some embodiments, the time stamp may be acquired by the pass authorization application 250-1 from the networked source 220 via the network communication unit 410.

With the pass information received, the pass information formatter 430 may be provided to organize, at 425, the content included in the pass into certain format or data structure for encoding purposes. On the other hand, based on the time Ti associated with the pass issuance time, the time stamp generator 440 may be provided to create, at 435, a time stamp for encoding. In the meantime, the information from the event/service provider 210 may also specify to acquire certain biometric information of the pass holder for verification purpose. Such specification may be determined, at 445, in order to acquire needed biometric information from the user. Based on such specification, the biometric information acquisition unit 420 may be provided to access, at 455, sensor(s) of appropriate type(s) on the handheld device 250 and the user 240 to acquire, at 465, the specified type(s) of biometric information.

To encoding the biometric information for verification, the biometric feature extractor 450 may be provided to process the acquired biometric information to extract, at 475, e.g., signature features that may be used to identify the user. The pass, the time stamp, and the biometric features may then be forwarded to the encryption unit 460, which may encrypt, at 485, the information received and send to the barcode generator 470 to generate, at 495, a barcode 260 based on encrypted information. In some embodiments, additional information may also be included in the barcode such as the type(s) of biometric information, payment status, etc. What is shown herein are merely for illustration instead of limitation and it is understood that any other information, whether verification related or not, may also be encoded to generate a barcode.

FIG. 5A depicts an exemplary high level system diagram of the entrance admission unit 270, in accordance with an embodiment of the present teaching. As discussed herein, the entrance admission unit 270 is provided to read an optical signal associated with a pass to an event and verify the validity of the pass and the identity of the pass holder. In this illustrated embodiment, the optical signal corresponds to a barcode. It is understood, however, that a barcode is merely for illustration instead of limitation to the present teaching. In addition, an optical signal is also for illustration purposes. In some embodiments, it is also possible to generate an encrypted bit stream encoding information related to a timed pass and biometric information of a pass holder so that the bit stream may be transmitted, via either wired connection or a wireless connection, to a verification authority to carry out the verification as disclosed herein.

The entrance admission unit 270 as shown in FIG. 5A comprises a barcode reader 500, a decryption unit 510, a pass validity determiner 520, an on-site biometric information acquisition controller 530, an on-site biometric feature extractor 540, a biometric-based identity comparator 550, and an entrance authorization unit 570. The barcode reader 500 is provided for reading a barcode presented by a user via a handheld device. The information read from the barcode may then be sent to the decryption unit 510 so that it can be decrypted to obtain different types of information, including, e.g., information related to the pass, information related to the time stamp, the information related to the biometric information of an authorized holder of the pass, etc.

Different types of information obtained from the barcode may then be used for different aspects of the verification. For example, information related to the time stamp Ti may be provided to the pass validity determiner 520. To check the validity of the pass, the pass validity determiner 520 may obtain, e.g., from the networked source 220, the current time Tj and compare Ti and Tj to determine whether the pass as presented is still valid. If the pass is no longer valid, the pass validity determiner 520 sends a signal indicating the validity of the pass to the entrance authorization unit 570. In this case, the entrance authorization unit 570 may accordingly make a deny decision on the user's access to the event and send the decision to the event/service access control unit 290 to implement the denial decision by, e.g., blocking the entrance. If the pass is valid, the pass validity determiner 520 invokes the biometric-based identity comparator 550 to proceed to the identity verification.

Upon receiving the signal from the pass validity determiner 520, the biometric-based identity comparator 550 may be provided to carry out the task of verifying whether the user presenting the pass at the event site is the user who was previously authorized with the pass via biometric information. In some embodiments, the biometric-based identity comparator 550 may determine first on the type of biometric information to be used for the verification based on an indication of the biometric information type decrypted from the barcode. Based on the information on the type of biometrics, the on-site biometric information acquisition controller 530 is invoked to acquire the needed type of biometric information. The controller 530 may then communicate with the biometric information acquisition unit 280 (see FIG. 2A) to instruct the type of biometric information to be acquired.

Upon receiving the biometric information acquired on-site from the user, it is forwarded to the on-site biometric feature extractor 540 to extract features from the on-site biometric information. The extracted on-site biometric features are then provided to the biometric-based identity comparator 550 to determine whether the biometric information from the barcode (representing the identity of the user who was previously authorized) matches with the on-site biometric information (representing the identity of the person at the event who presented the barcode to access the event). If a match is found, determined based on specified matching criterion 560,

FIG. 5B is a flowchart of an exemplary process of the entrance admission unit 270, in accordance with an embodiment of the present teaching. When the barcode reader 500 senses a barcode provided by the user 240, it reads, at 505, the barcode and provide the barcode to the decryption unit 510, which may then proceed to decrypt, at 515, the barcode to obtain various types of information encoded therein, including but is not limited to, a time stamp Ti, content associated with a pass (e.g., identification of the event, date/time of the event, and seating information), biometric feature of the holder of the pass, and other information such as the type of biometrics used for verification, payment status, etc. Based on the decrypted information, the entrance admission unit 270 may proceed to verify the authorization in terms of both the validity of the pass itself as well as the identity of the holder of the pass.

To verify the validity of the pass, the pass validity determiner 520 obtains, at 525, the current time Tj from, e.g., the networked source 220 and then determines, at 535, whether the pass presented is valid based on Ti and Tj. If the pass is not valid (e.g., expired), decided at 545, the entrance authorization unit 570 is invoked to issue, at 555, an instruction to the event/service access control unit 290 to deny the user's access to the event. If the pass is valid, the biometric-based identity comparator 550 is invoked to perform the verification of the user's identity. To do so, the biometric-based identity comparator 550 may determine the type of biometric information to be acquired for the verification. In some embodiments, a predetermined default type of biometric information may be used (e.g., fingerprint). In some embodiments, the type may be adaptively applied to each individual situations so that the type of biometrics used in each situation may be dynamically determined based on, e.g., what is specified when the pass is generated and encoded in the barcode.

As discussed herein, the biometric-based identity comparator 550 may identify the specification on the type of biometric information from the decrypted barcode and accordingly invoke the on-site biometric information acquisition controller 530 to control, at 565, the acquisition of the on-site biometric information of the specified type by collaborating with the biometric information acquisition unit 280 (see FIG. 2A). With the acquisition of the on-site biometric information, the on-site biometric feature extractor 540 processes the acquired on-site biometric information and extracts the on-site biometric features, which is then sent to the biometric-based identity comparator 550 for identity verification.

To carry out the identity verification, the biometric-based identity comparator 550 accesses, from the decrypted barcode, the biometric features previously generated based on the user's biometric information acquired at the time of issuing the pass and perform identity verification, at 575, by, e.g., comparing the two correspond sets of biometric features. If no match is found, determined at 585, the entrance authorization unit 570 is invoked to issue, at 555, an instruction to the event/service access control unit 290 to deny the user's access to the event. In some embodiments, if there is a match, the entrance authorization unit 570 is invoked to issue, at 597, an instruction to the event/service access control unit 290 to allow the user's entrance to the event. See dotted line in FIG. 5B. In some embodiments, there may be other conditions that may need to be verified. For instance, the payment status may also need to be verified based on information provided with the barcode. In this case, the biometric-based identity comparator 550 may inform the entrance authorization unit 570 about the match so that the entrance authorization unit 570 may proceed to verify, at 590, other conditions to be met before access. If the verification of other conditions is successful, determined at 595, the entrance authorization unit 570 issues, at 597, an instruction to the event/service access control unit 290 to allow the user's entrance to the event. Otherwise, the entrance authorization unit 570 issues, at 555, an instruction to the event/service access control unit 290 to deny the user's access to the event.

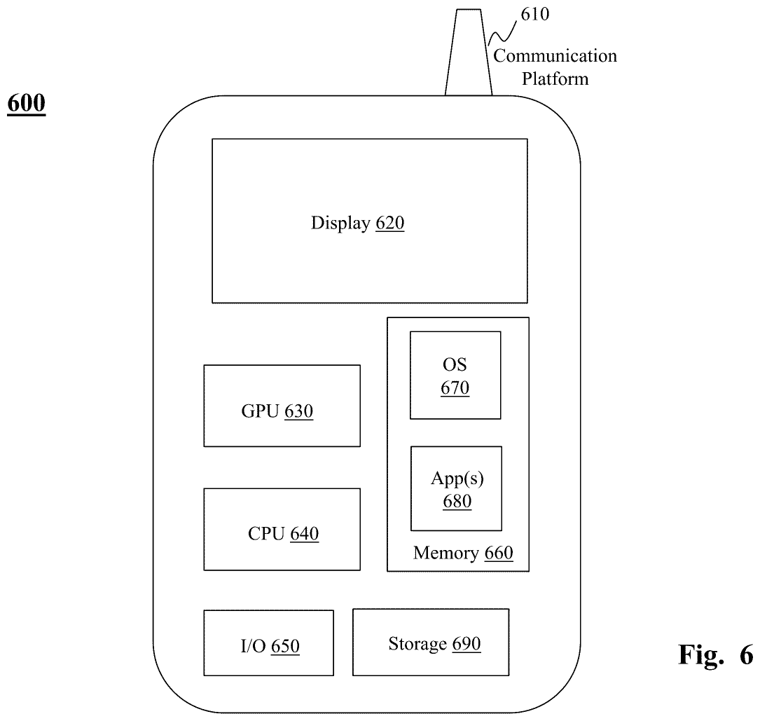

FIG. 6 is an illustrative diagram of an exemplary mobile device architecture that may be used to realize a specialized system implementing the present teaching in accordance with various embodiments. In this example, the user device on which the present teaching may be implemented corresponds to a mobile device 600, including, but not limited to, a smart phone, a tablet, a music player, a handled gaming console, a global positioning system (GPS) receiver, and a wearable computing device, or in any other form factor. Mobile device 600 may include one or more central processing units (“CPUs”) 640, one or more graphic processing units (“GPUs”) 630, a display 620, a memory 660, a communication platform 610, such as a wireless communication module, storage 690, and one or more input/output (I/O) devices 650. Any other suitable component, including but not limited to a system bus or a controller (not shown), may also be included in the mobile device 600. As shown in FIG. 6, a mobile operating system 670 (e.g., iOS, Android, Windows Phone, etc.), and one or more applications 680 may be loaded into memory 660 from storage 690 in order to be executed by the CPU 640. The applications 680 may include a user interface or any other suitable mobile apps for information analytics and management according to the present teaching on, at least partially, the mobile device 600. User interactions, if any, may be achieved via the I/O devices 650 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

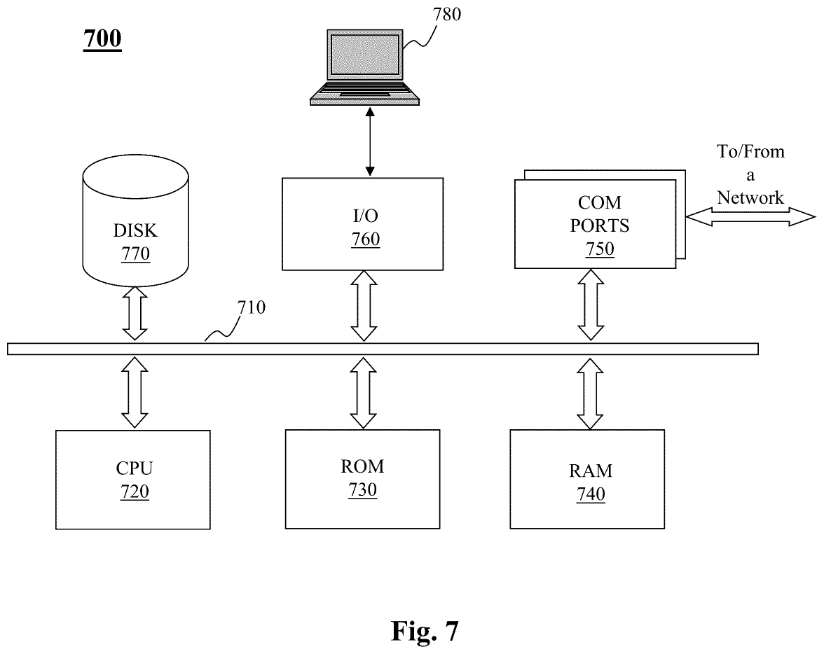

FIG. 7 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 900 may be used to implement any component or aspect of the framework as disclosed herein. For example, the information analytical and management method and system as disclosed herein may be implemented on a computer such as computer 700, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 700, for example, includes COM ports 750 connected to and from a network connected thereto to facilitate data communications. Computer 700 also includes a central processing unit (CPU) 720, in the form of one or more processors, for executing program instructions. The exemplary computer platform includes an internal communication bus 710, program storage and data storage of different forms (e.g., disk 970, read only memory (ROM) 730, or random-access memory (RAM) 740), for various data files to be processed and/or communicated by computer 700, as well as possibly program instructions to be executed by CPU 720. Computer 700 also includes an I/O component 760, supporting input/output flows between the computer and other components therein such as user interface elements 780. Computer 700 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, comprising:
obtaining, by a user via a handheld device via a network connection, an electronic pass to attend an event at a future time in accordance with one or more parameters in connection with the event;
acquiring biometric information of the user using a sensor embedded in the handheld device;
generating a time stamp based on a current date/time associated with the electronic pass;
creating an optical signal on the handheld device that encrypts information needed for an entrance to the event, including the electronic pass, the time stamp, and features of the biometric information of the user;
presenting, subsequently by the user at the event via the handheld device, the optical signal for verification prior to entering the event.

2. The method of claim 1, wherein
the handheld device corresponds to one of a smart phone, a tablet, a personal data assistant, a wristwatch, and a mobile device; and
the biometric information is one or more of:
a fingerprint,
a face,
a palm, and
an iris.

3. The method of claim 1, wherein the one or more parameters in connection with the event includes at least one of an identifier for uniquely identifying the event, a date and time of the event, a seating arrangement associated with the user at the event, a type of biometric information to be used for identity verification, a cost of the event, and a status of payment of the event.

4. The method of claim 1, wherein the step of obtaining an electronic pass comprises:
interfacing, via the handheld device, with a remote site that manages the event;
selecting the event that the user intends to attend with the remote site;
determining interactively the one or more parameters associated with the user's participation of the event.

5. The method of claim 3, wherein the step of creating an optical signal comprises:
processing the acquired biometric information of the user to extract the biometric features;
recording the type of biometric information;
encoding the information needed for verification at the event for an authorized entrance;
generating the optical signal based on the encoded information.

6. The method of claim 5, wherein the optical signal corresponds to a barcode.

7. The method of claim 1, wherein the step of presenting the optical signal comprise one of:
displaying the optical signal on a display screen of the handheld device so that the optical signal is to be read wirelessly;
transmitting the optical signal via a network connection to a receiving means on-site of the event, wherein
the network connection is one of a wired connection or a wireless connection.

8. The method of claim 1, further comprising:
decrypting the optical signal presented by the user to obtain the information encoded therein, including the electronic pass, the time stamp, and the biometric features of the biometric information acquired from the user at the time of generating the electronic pass;
determining a type of the biometric information;
acquiring on-site biometric information of the user of the type;
verifying the electronic pass and the identity of the user via the type of biometric information; and
controlling the access of the user to the event based on the verification result.

9. A machine-readable medium having information recorded thereon, wherein the information, when read by the machine, causes the machine to perform the following steps:
obtaining, by a user via a handheld device via a network connection, an electronic pass to attend an event at a future time in accordance with one or more parameters in connection with the event;
acquiring biometric information of the user using a sensor embedded in the handheld device;
generating a time stamp based on a current date/time associated with the electronic pass;
creating an optical signal on the handheld device that encrypts information needed for an entrance to the event, including the electronic pass, the time stamp, and features of the biometric information of the user;
presenting, subsequently by the user at the event via the handheld device, the optical signal for verification prior to entering the event.

10. The medium of claim 9, wherein
the handheld device corresponds to one of a smart phone, a tablet, a personal data assistant, a wristwatch, and a mobile device; and
the biometric information is one or more of:
a fingerprint,
a face,
a palm, and
an iris.

11. The medium of claim 9, wherein the one or more parameters in connection with the event includes at least one of an identifier for uniquely identifying the event, a date and time of the event, a seating arrangement associated with the user at the event, a type of biometric information to be used for identity verification, a cost of the event, and a status of payment of the event.

12. The medium of claim 9, wherein the step of obtaining an electronic pass comprises:
interfacing, via the handheld device, with a remote site that manages the event;
selecting the event that the user intends to attend with the remote site;
determining interactively the one or more parameters associated with the user's participation of the event.

13. The medium of claim 11, wherein the step of creating an optical signal comprises:
processing the acquired biometric information of the user to extract the biometric features;
recording the type of biometric information;
encoding the information needed for verification at the event for an authorized entrance;
generating the optical signal based on the encoded information.

14. The medium of claim 13, wherein the optical signal corresponds to a barcode.

15. The medium of claim 9, wherein the step of presenting the optical signal comprise one of:
displaying the optical signal on a display screen of the handheld device so that the optical signal is to be read wirelessly;
transmitting the optical signal via a network connection to a receiving means on-site of the event, wherein
the network connection is one of a wired connection or a wireless connection.

16. The medium of claim 9, wherein the information, when read by the machine, further causes the machine to perform the following steps:
decrypting the optical signal presented by the user to obtain the information encoded therein, including the electronic pass, the time stamp, and the biometric features of the biometric information acquired from the user at the time of generating the electronic pass;
determining a type of the biometric information;
acquiring on-site biometric information of the user of the type;
verifying the electronic pass and the identity of the user via the type of biometric information; and
controlling the access of the user to the event based on the verification result.

17. A system, comprising:
a pass authorization application implemented by a processor and configured for operating on a handheld device for
obtaining, by a user via a network connection, an electronic pass to attend an event at a future time in accordance with one or more parameters in connection with the event,
acquiring biometric information of the user using a sensor embedded in the handheld device,
generating a time stamp based on a current date/time associated with the electronic pass, and
creating an optical signal on the handheld device that encrypts information needed for an entrance to the event, including the electronic pass, the time stamp, and features of the biometric information of the user;
an entrance admission unit implemented by a processor and configured for receiving the optical signal, provided subsequently by the user at the event via the handheld device, for verification prior to entering the event.

18. The system of claim 17, wherein
the handheld device corresponds to one of a smart phone, a tablet, a personal data assistant, a wristwatch, and a mobile device; and
the biometric information is one or more of:
a fingerprint,
a face,
a palm, and
an iris.

19. The system of claim 17, wherein the one or more parameters in connection with the event includes at least one of an identifier for uniquely identifying the event, a date and time of the event, a seating arrangement associated with the user at the event, a type of biometric information to be used for identity verification, a cost of the event, and a status of payment of the event.

20. The system of claim 17, wherein the step of obtaining an electronic pass comprises:
interfacing, via the handheld device, with a remote site that manages the event;
selecting the event that the user intends to attend with the remote site;
determining interactively the one or more parameters associated with the user's participation of the event.

21. The system of claim 19, wherein the step of creating an optical signal comprises:
processing the acquired biometric information of the user to extract the biometric features;
recording the type of biometric information;
encoding the information needed for verification at the event for an authorized entrance;
generating the optical signal based on the encoded information.

22. The system of claim 21, wherein the optical signal corresponds to a barcode.

23. The system of claim 17, wherein the step of presenting the optical signal comprise one of:
displaying the optical signal on a display screen of the handheld device so that the optical signal is to be read wirelessly;
transmitting the optical signal via a network connection to a receiving means on-site of the event, wherein
the network connection is one of a wired connection or a wireless connection.

24. The system of claim 17, wherein the entrance admission unit further comprises:
a decryption unit implemented by a processor and configured for decrypting the optical signal presented by the user to obtain the information encoded therein, including the electronic pass, the time stamp, and the biometric features of the biometric information acquired from the user at the time of generating the electronic pass;
an on-site biometric information acquisition controller implemented by a processor and configured for determining a type of the biometric information;
a biometric information acquisition unit implemented by a processor and configured for acquiring on-site biometric information of the user of the type;
an entrance authorization unit implemented by a processor and configured for
verifying the electronic pass and the identity of the user via the type of biometric information, and
controlling the access of the user to the event based on the verification result.
